(19) United States
(12) Patent Application Publication
(10) Pub. No.: US 2002/0022130 A1
(43) Pub. Date: Feb. 21, 2002

(54) UV-curable binder composition for magnetic recording media and photoinitiator mixture

(75) Inventors: Albert Kohl, Laumersheim (DE); Wolfgang Reich, Maxdorf (DE); August Lehner, Rodersheim-Gronau (DE); Gunther Heil, Ludwigshafen (DE); Volker Koch, Battenberg (DE); Josef Schelble, Zusmarshausen (DE); Karl-Heinz Romer, Frankenthal (DE); Franz Weingart, Weinheim (DE)

Correspondence Address: GREENBLUM & BERNSTEIN, P.L.C., 1941 ROLAND CLARKE PLACE, RESTON, VA, 20191, US

(73) Assignee: EMTEC MAGNETICS GmbH, Ludwigshafen (DE)

(21) Appl. No.: 09/851,385

(22) Filed: May 9, 2001

Related U.S. Application Data
(63) Continuation of application No. PCT/EP99/07554, filed on Oct. 8, 1999.

(30) Foreign Application Priority Data
Nov. 9, 1998 (DE) P 198 51 567.7

(51) Int. Cl. B05D 3/06; H01F 1/00; B32B 3/02

(52) U.S. Cl. 428/423.1; 427/558; 252/62.51 R; 428/65.1

(57) ABSTRACT

A UV-curable binder composition, a coating material which contains such a binder composition, a photoiniator mixture suitable for use in these coating materials, and a magnetic recording medium which contains such a UV-curable coating material are described.

### CROSS-REFERENCE TO RELATED APPLICATIONS

This application is a Continuation of PCT/EP99/07554, filed Oct. 8, 1999, which was not published in English (being published in German), which is incorporated by reference herein in its entirety, and claims priority of German Application No. 198 51 567.7, filed Nov. 9, 1998.

### BACKGROUND OF THE INVENTION

1. Field of the Invention

The present invention relates to a UV-curable binder composition, a coating material which contains such a binder composition, a photoinitiator mixture suitable for use in these coating materials and a magnetic recording medium which contains such a UV-curable coating material.

2. Discussion of Background Information

Magnetic recording media are widely used for recording and playback of audio and video information and of data. The constantly increasing requirements which these media have to meet necessitate continuous improvements in magnetic and electroacoustic aspects and also with regard to the aging resistance. In addition to very good recording and playback properties, magnetic recording media should therefore have high mechanical stability and durability, preferably also under extreme conditions of use, such as at high temperature and high atmospheric humidity. For this purpose, the magnetic layers must be very flexible, must have high resilience and must possess high tensile strength. In addition, in order to avoid drops in output level, a reduction in the coefficients of friction and an increase in the abrasion resistance and wear resistance are required.

The abovementioned requirements are generally not simultaneously met by the known two-layer magnetic recording media which comprise the magnetic materials dispersed in an organic binder on a substrate material, generally a film, for example of linear polyesters, such as polyethylene terephthalate. Many magnetic recording media therefore have a plurality of layers.

In addition to one or more magnetic layers, intermediate or adhesion-promoting layers and backing coatings and top layers may also be present. These serve, for example, for improving the adhesion of the magnetic layer, improving the mechanical properties of the tape and/or preventing a build-up of electrostatic charge. Backing coatings are intended to prevent, for example, the sticking together of the tape layers, a build-up of electrostatic charge and/or creasing of the tape. Top layers counteract the abrasion of the magnetic layer and hence soiling of the recording and playback apparatuses. Intermediate layers, in particular adhesion-promoting layers, between substrate material and magnetic layer are intended to increase the mechanical load-bearing capacity of the tape and to ensure uniformity of the magnetic layer by improving the adhesion.

A known problem of multilayer magnetic recording media, in particular of magnetic tapes, is the build-up of electrostatic charge as a result of friction and charge separation during rewinding and unwinding. It is furthermore known that carbon black dispersed in the magnetic recording media can be used for avoiding this build-up of electrostatic charge. If the carbon black is used directly in the magnetic layer, good electrostatic properties are generally obtained, but with a simultaneous deterioration in the residual induction. In order to avoid this effect, the carbon black is therefore generally used in a layer on the back of the substrate or as a component of the adhesion-promoting layer between substrate material and magnetic layer. The binders used for this adhesion-promoting or primer layer must permit sufficient dispersing both of the carbon black and, if required, of further pigments, such as CrO₃, CaCO₃ etc., used as additives.

Various binders have been proposed as a basis for the adhesion-promoting layer. When thermoplastic resins are used as binders, there is the problem that, on application of the magnetic coating material, which is usually dispersed in a considerable amount of solvent, the adhesion-promoting layer formed beforehand swells or is dissolved by the solvent, so that the coating becomes nonuniform and the smooth surface of the magnetic layer is not obtained. In the case of heat-curable or chemically curable resins, there is the problem of a comparatively long curing time. In general, they therefore cannot be used in the continuous production processes usual today for magnetic tapes. In recent years, radiation curing processes have therefore become very important. Compared with chemical or heat curing, radiation-curing has many advantages, such as saving of raw materials, reduced environmental pollution and energy saving, since solvent-free or low-solvent systems can be used, and a high curing rate and little thermal stressing of the substrate.

Radiation curing of the binders used for the adhesion-promoting layer is generally effected by electron beams. The disadvantage of this curing process is the large amount of space required, the high safety-related costs and the high maintenance cost of the units used. It is therefore desirable to use UV radiation for curing layers in magnetic recording materials. However, various problems arise. Since the binder compositions used as primer layer or adhesion-promoting layer are generally highly pigmented, preferably with carbon black, the curing rate is greatly reduced compared with electron beams, and crosslinking requires long residence times or takes place only incompletely. Attempts to solve these problems by increasing the double bond concentration in the binders or reducing the molecular weight of the components of the binders generally lead to a deterioration in the performance characteristics, for example shrinkage of the material during irradiation. This leads to creasing of the substrate, with the result that the magnetic recording media are useless. Furthermore, many binder compositions usually used for UV curing are not suitable for the dispersing of carbon black and/or other pigments. In general, agglomeration or speck formation then occurs.

U.S. Pat. No. 3,874,906 describes a process for coating various substrates, such as paper, metals, plastics and cellulose, a radiation-curable composition, which contains a polyesteracrylate and N-vinylpyrrolidone as a viscosity-reducing additive, being used. The use of these radiation-curable binders in pigment-containing coating materials is not described.

U.S. Pat. No. 4,129,709 describes radiation-curable coating materials which contain a urethane acrylate oligomer, N-vinylpyrrolidone and an acrylate. Among the additives for these coating materials, very generally pigments and carbon black are also mentioned. However, there is no use example for a pigment-containing coating material, especially not for a UV-curable, carbon black-containing coating material.

U.S. Pat. No. 4,348,427 describes a process for coating various surfaces, e.g. wood, plastics etc., with a radiation-curable coating material. This contains at least one compound which is selected from epoxy acrylates, polyester acrylates and urethane acrylates and at least one N-vinylarnide of a carboxylic, sulfonic or phosphonic acid. These coating materials can be crosslinked by UV radiation at a wavelength of from 200 to 400 nm in the presence of a photoinitiator. Carbon black-containing coating materials are not described in this document.

EP-A-0 559 135 describes a radiation-curable formulation containing:

a) an oligomer selected from epoxy acrylates, polyester acrylates, polyurethane acrylates and mixtures thereof,

b) N-vinylformamide and, if required, a further mono-, di- or polyfunctional vinyl or acryloyl monomer. These formulations are said to be suitable for pigmented and unpigmented coatings. Suitable pigments and in particular carbon black are, however, not disclosed in this document.

EP-A-0 632 111 has a disclosure content comparable to EP-A-0 559 135.

In Radiation Curing in Polymer Science and Technology, Volume 4, page 216 et seq., Elsevier 1993, the use of monofunctional monomers, such as N-vinylpyrrolidone and N-vinylcaprolactam, as reactive diluents for radiation-curable polyfunctional (meth)acrylates is described.

EP-A-0 033 897 describes a process for the preparation of polyurethane elastomers which have α,β-ethylenically unsaturated double bonds and are suitable for UV curing. These polyurethane elastomers can be used for the production of moldings, laminates, adhesives, coating materials and magnetic tapes. Mixtures of these polyurethaneacrylates with further α,β-ethylenically unsaturated compounds, in particular N-vinylamides, N-vinyllactams and vinyl- and allyl-substituted heteroaromatic compounds, are not described in this document. Use in pigment-containing, in particular carbon black-containing, coating materials is likewise not described.

EP-A-0 169 524 describes a magnetic recording medium in which the magnetic material is dispersed as a binder in a polyurethane elastomer whose composition essentially corresponds to that of the polyurethane elastomer described in EP-A-0 033 897. The magnetic recording media have no pigment-containing or carbon black-containing priming layer between substrate and magnetic layer. Carbon black is mentioned only generally as an additive for the magnetic layer, and an embodiment comprising a carbon black-containing magnetic layer is not described. The magnetic recording layer is cured by means of electron beams. It is true that reference is made in the description very generally to a possibility for slight prepolymerization of the coating also with UV light, in which case a conventional photoinitiator is required. However, individual photoinitiators are not mentioned.

DE-A-34 18 482 describes magnetic recording media comprising a nonmagnetic substrate material and at least one magnetic layer, the binder of the magnetic layer being curable by electron beams. It consists of from 60 to 100% by weight of a polyurethaneacrylate polymer having unsaturated double bonds and from 0 to 40% by weight of a further α,β-ethylenically unsaturated compound which is selected from acrylate monomers, acrylate prepolymers and/or N-vinyl monomers. The polyurethaneacrylate has an average number of more than 2 and less than 4 acrylate groups per average molecule. Magnetic recording media which have a priming layer between substrate and magnetic layer are not mentioned. A use of the binders used for the magnetic layer for dispersing carbon black is likewise not mentioned. The use of UV light is described only for the slight prepolymerization of the coating, in which case a conventional highly absorbent photoinitiator is required. Once again, no mention is made of suitable photoinitiators.

DE-A-34 28 943 describes a magnetic recording medium comprising a substrate, a priming coating on this substrate and a magnetic coating on the priming coating. This priming coating is obtained by dispersing carbon black in a radiation-curable coating material and curing the resulting dispersion by irradiation. The coating material essentially comprises at least two compounds which are selected from:

A) compounds having a molecular weight of at least 5000 and containing at least two radiation-curable, unsaturated double bonds,

B) compounds having a molecular weight of at least 400 and less than 5000 and containing at least one radiation-curable, unsaturated double bond, and

C) compounds having a molecular weight of less than 400 and containing at least one radiation-curable, unsaturated double bond.

Coating materials which contain N-vinylamides, N-vinyllactams or vinyl- and allyl-substituted heteroaromatic compounds are not described. Although this document mentions generally that the carbon black-containing coating material of the priming coating can be cured by UV irradiation, it being possible to use a conventional sensitizer, in the examples the curing is effected exclusively by electron beams. Photoinitiator mixtures are likewise not mentioned in this document.

A large number of photoinitiators are known for curing coating materials by means of UV irradiation. An overview of various photoinitiators appears, for example, in Radiation Curing in Polymer Science and Technology; Volume 2, Photoinitiating Systems, Elsevier 1993. Suitable photoinitiator mixtures for curing carbon black-containing coating materials are not described in this document.

DE-A-40 25 386 describes photoinitiators of the acylphosphine oxide type and a process for curing materials, coatings and printing inks, capable of free radical polymerization, by UV irradiation in the presence of these photoinitiators. The acylphosphine oxides can be combined with other photoinitiators, such as ketals, benzophenones or thioxanthones. The curable material may be transparent or contain conventional organic or inorganic pigments.

DE-A-42 40 964 describes arenebisphosphine oxides and photopolymerizable materials which contain them as photoinitiators. Mixtures of the arenebisphosphine oxides with other photoinitiators may also be used.

EP-A-0 184 095 describes bisacylphosphine oxides and their use as photoinitiators and photopolymerizable materials. Combinations of these bisacylphosphine oxides with other photoinitiators are mentioned only very generally.

EP-A-0 413 657 describes mono- and diacylphosphine oxides and photopolymerizable compositions which contain them. Mixtures with other photoinitiators, for example with benzophenone, acetophenone derivatives, benzoin ethers or benzil ketals, may also be used.

EP-A-0 495 751 describes bisacylphosphines and photopolymerizable compositions which contain them. Mixtures with further photoinitiators or photosensitizers are also mentioned very generally.

DE-A-38 26 947 describes thioxanthone derivatives which simultaneously have an alkylphenone group, and photopolymerizable binder systems which contain these derivatives as photoinitiators. These binder systems are conventional finishes or polymer coatings and printing inks and preferably pigmented systems. A combination of these photoinitiators with conventional photoinitiators is mentioned only generally.

Photoinitiator mixtures which contain an acylphosphine oxide or sulfide, an α-cleaver and an H-abstractor and their use in carbon black-containing, UV-curable coating materials are not described in the abovementioned documents.

DE-A-42 31 579 describes alkylbisacylphosphine oxide photoinitiators and their use in photopolymerizable compositions. These compositions may be radiation-curable aqueous polymer dispersions, conventional pigments and carbon black also being mentioned as additives. The bisacylphosphine oxides may also be used in the form of mixtures with known photoinitiators, such as benzophenone, acetophenone derivatives, benzoin ethers, benzil ketals, monoacylphosphine oxides, further bisacylphosphine oxides, peresters or titanocenes. Photoinitiator mixtures comprising three or more components and containing at least one acylphosphine oxide or sulfide, an α-cleaver and an H-abstractor are not disclosed. The examples, too, make no mention of a photoinitiator mixture which comprises three different photoinitiators. Furthermore, there is no example for carbon black-containing, UV-curable coating materials.

EP-A-0 615 980 describes a process for curing ethylenically unsaturated polymerizable compounds in the presence of a bisacylphosphine oxide photoinitiator. The ethylenically unsaturated compounds can be used in the form of radiation-curable aqueous prepolymer dispersions, carbon black also being listed very generally as an additive to these dispersions. Mixtures of the bisacylphosphine oxide photoinitiators with other photoinitiators, such as benzophenone, acetophenone derivatives, benzoin alkyl ethers and benzil ketals, are also mentioned only very generally. Photoinitiator mixtures which contain an acylphosphine oxide or sulfide, an α-cleaver and an H-abstractor are not described. Furthermore, there is no example for a carbon black-containing, UV-curable coating material.

EP-A-0 446 175 describes photoinitiator mixtures comprising

a) 100 parts of a mono- or diacylphosphine oxide,

b) from 10 to 70 parts of an α-hydroxyacetophenone and

c) from 10 to 70 parts of a benzophenone.

They are suitable in particular for the UV curing of coating materials pigmented with TiO₂ (white coatings). Their use in carbon black-containing, UV-curable coating materials is not described. Photoinitiator mixtures which contain an acylphosphine oxide or sulfide, an α-cleaver and an H-abstractor and their use in carbon black-containing, UV-curable coating materials are not described in the above-mentioned documents.

EP-A-0 418 011 describes photocurable resins which are prepared by reaction of acrylic acid with an epoxy resin of the cresol novolak type and subsequent reaction with a dicarboxylic anhydride in the absence of an amine or phosphine catalyst and are used in solder resist materials.

In an example, a mixture of 2-ethylanthraquinone, acylphosphine oxide, 2-isopropylthioxanthone, 1-hydroxycyclohexylacetophenone and further additives is added to the resin thus prepared, the resulting solder resist material being applied to a substrate, dried by means of elevated temperatures and then exposed through a diazo or silver halide screen, and the unexposed parts then being removed by spraying on an aqueous sodium carbonate solution. A photocured resin is obtained only in the areas where a photochemical dye development takes place.

The use of a mixture, which contains acylphosphine oxide, 2-isopropylthioxanthone and 1-hydroxycyclohexylacetophenone, as photoinitiator in carbon black-containing, UV-curable coating materials is not described.

### SUMMARY OF THE INVENTION

It is an object of the present invention, on the one hand, to provide a novel, UV-curable binder composition. This should preferably be suitable for use in pigment-containing, in particular carbon black-containing, coating materials. It is a further object of the present invention to provide a photoinitiator mixture for use in pigment-containing, in particular carbon black-containing, coating materials. The carbon black-containing coating materials should likewise be UV-curable and suitable in particular as a priming layer in magnetic recording media.

### DETAILED DESCRIPTION OF THE PRESENT INVENTION

We have found, surprisingly, that the first object is achieved by a UV-curable binder composition comprising

a) at least one polyurethaneacrylate having a number average molecular weight of from 10,000 to 80,000 and an average number from 4 to 15 of UV-curable α,β-ethylenically unsaturated double bonds per molecule,

b) at least one compound having a molecular weight of from 254 to 1000 and three UV-curable α,β-ethylenically unsaturated double bonds per molecule,

c) at least one compound having a molecular weight from 170 to 1000 and two UV-curable α,β-ethylenically unsaturated double bonds per molecule,

d) at least one α,β-ethylenically unsaturated compound which is selected from N-vinylamides, N-vinyllactams, vinyl- and allyl-substituted heteroaromatic compounds and mixtures thereof, and

e) if required, at least one ester of an α,β-ethylenically unsaturated monocarboxylic acid with an aliphatic or cycloaliphatic C₁- to C₂₀-monoalcohol.

This is preferably a binder composition comprising:

from 0.003 to 0.015 mol of at least one polyurethaneacrylate a),

from 0.2 to 1.5 mol of at least one compound b),

from 0.2 to 1.8 mol of at least one compound c),

from 0.1 to 4.0, preferably from 0.3 to 4.0, mol of at least one α,β-ethylenically unsaturated compound d) which is selected from N-vinylamides, N-vinyllactams, vinyl- and allyl-substituted heteroaromatic compounds and mixtures thereof, and

from 0 to 4.0 mol of at least one ester e) of an α,β-ethylenically unsaturated monocarboxylic acid with an aliphatic or cycloaliphatic C₁- to C₂₀-monoalcohol.

Preferably, the content of UV-curable, α,β-ethylenically unsaturated double bonds is from about 2.5 to 7.0, preferably from 4.0 to 6.0, mol per 1000 g of binder composition.

Preferably, the average double bond functionality is not more than 1.8, preferably not more than 1.6, per molecule, based on the components a) to e). Preferably, the average double bond functionality is at least 0.3, preferably at least 0.5, per molecule, based on the components a) to e).

### Component a)

Preferably, the polyurethaneacrylate a) has a number average molecular weight of from about 10,000 to 80,000, preferably from about 15,000 to 50,000.

The polyurethaneacrylate a) is preferably composed of

A) at least one compound having at least two terminal isocyanate groups, which is selected from diisocyanates, isocyanate prepolymers, polyisocyanates and mixtures thereof,

B) at least one compound having a molecular weight of from 146 to 3000 and at least one α,β-ethylenically unsaturated double bond and at least two hydroxyl groups per molecule,

C) at least one compound which has at least one α,β-ethylenically unsaturated double bond and one hydroxyl group per molecule,

D) at least one polymer having two or more hydroxyl groups per molecule, and

E) if required, at least one compound which differs from A) to D), has two or more active hydrogen atoms per molecule and is selected from diols, amines having at least two primary and/or secondary amino groups per molecule, amino alcohols, triols, polyols, water and mixtures thereof.

Preferred compounds A) having at least two terminal isocyanate groups are selected from compounds having from 2 to 5 isocyanate groups, isocyanate prepolymers having an average number of from 2 to 5 isocyanate groups, and mixtures thereof. These include, on the one hand, organic di-, tri- and polyisocyanates.

Suitable diisocyanates A) are, for example, tetramethylene diisocyanate, hexamethylene diisocyanate, 2,3,3-trimethylhexamethylene diisocyanate, cyclohexylene 1,4-diisocyanate, dicyclohexylmethane diisocyanate, isophorone diisocyanate, phenylene 1,4-diisocyanate, toluene 2,4- and 2,6-diisocyanate and the isomer mixtures thereof, naphthylene 1,5-diisocyanate, diphenylmethane 2,4- and 4,4′-diisocyanate and mixtures thereof. A suitable triisocyanate A) is, for example, triphenylmethane 4,4′,4″-triisocyanate. Prepolymers having at least two free isocyanate groups and obtained from at least two identical or different diisocyanates and the diols and polydiols stated below are furthermore suitable. Diphenylmethane 2,4- and 4,4′-diisocyanate, isophorone diisocyanate, toluene 2,4- and 2,6-diisocyanate, dicyclohexylmethane diisocyanate and mixtures thereof are preferred.

Isocyanate prepolymers having a number average molecular weight of up to about 10,000, preferably from about 500 to 3000, are also suitable. These are obtained, for example, by an addition reaction of the abovementioned isocyanates with polyfunctional hydroxyl- or amino-containing compounds. Polyisocyanates based on toluene diisocyanate, hexamethylene diisocyanate and/or isophorone diisocyanate and formed by a polyaddition reaction with di- or triols or by biuret, uretdione or isocyanurate formation are preferably used. Suitable diols and triols are described below as component E).

The reaction products of polyisocyanates with monofunctional compounds which are usually used for regulating the isocyanate group content, for example with at least one aliphatic, cycloaliphatic or aromatic monoalcohol, such as methanol, ethanol, n-propanol, isopropanol, n-butanol, tert-butanol, cyclohexanol and phenol, are also suitable. These reaction products preferably also have at least one or two isocyanate groups per molecule. The reaction products of polyisocyanates with phthalimide or caprolactam are also suitable.

The compounds of component A) can be used individually or in the form of mixtures.

Suitable compounds B) which have at least one α,β-ethylenically unsaturated double bond and at least two hydroxyl groups are, for example, the reaction products of epoxide compounds which have at least two epoxide groups with α,β-ethylenically unsaturated mono- and dicarboxylic acids and their anhydrides. Suitable epoxide compounds and their reaction products are described, for example, in DE-A-21 64 386, which is hereby incorporated by reference in its entirety. Diepoxide compounds used may be, for example, bisphenol A diglycidyl ether, resorcinol diglycidyl ether, 1,4-butanediol diglycidyl ether, diglycidyl ethers of polyalkylene glycols, such as polyethylene glycol, polypropylene glycol and copolymers of ethylene oxide and propylene oxide, diglycidyl esters of phthalic anhydride and maleic anhydride, bis(3,4-epoxy-6-methylcyclohexylmethyl) adipate, 3,4-epoxy-6-methylcyclohexylmethyl 3,4-epoxy-6-methylcyclohexanecarboxylate, dicyclopentadiene diepoxide and mixtures thereof. Suitable epoxide compounds are furthermore conventional epoxy resins, such as phenol and cresol epoxy novolaks, glycidyl ethers of phenol/aldehyde adducts, glycidyl ethers of phenol/hydrocarbon novolaks, glycidyl ethers of aliphatic diols, aromatic glycidylamines, heterocyclic glycidylimides and glycidylamides, glycidyl esters etc. α,β-Ethylenically unsaturated mono- and dicarboxylic acids suitable for reaction with these epoxide compounds are, for example, crotonic acid, fumaric acid, maleic acid, maleic anhydride, tetrahydrophthalic acid, tetrahydrophthalic anhydride, acrylic acid, methacrylic acid and mixtures thereof, preferably acrylic acid, methacrylic acid and mixtures thereof. If desired, the epoxides can also be reacted with an acid mixture comprising at least one of the abovementioned α,β-ethylenically unsaturated carboxylic acids and at least one saturated mono- and/or dicarboxylic acid. Suitable saturated carboxylic acids are, for example, formic acid, acetic acid, propionic acid, butyric acid, oxalic acid, malonic acid, succinic acid and mixtures thereof. By using mixtures of saturated and unsaturated mono- and/or dicarboxylic acids, the molecular weight and the double bond content of the compounds B) can be varied within a wide range. In general, the molar ratio of epoxide groups to carboxyl groups is from about 1:0.9 to 1:1.1.

Suitable compounds B) are furthermore the reaction products of saturated dicarboxylic acids with α,β-ethylenically unsaturated glycidyl compounds. Suitable dicarboxylic acids are, for example, oxalic acid, malonic acid, succinic acid, glutaric acid, adipic acid, pimelic acid, azelaic acid, sebacic acid etc. and mixtures thereof. For example, allyl glycidyl ether may be used as an olefinically unsaturated glycidyl compound.

Other suitable compounds B) are the reaction products of hydroxyl-carrying monoepoxides with the abovementioned α,β-ethylenically unsaturated mono- and dicarboxylic acids. The reaction products of glycidol (2,3-epoxy-1-propanol) with acrylic acid or methacrylic acid are preferred.

Other suitable compounds B) are the reaction products of the abovementioned α,β-ethylenically unsaturated mono- and dicarboxylic acids with epoxides, which contain two terminal epoxide groups, of the general formula

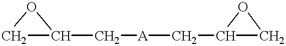

where

A is —O—,

a radical of the formula —O—(CH₂CH₂O)ₚ(CH₂CH(CH₃)O)_{q}—, where there may be any desired sequence of the alkylene oxide units, and p and q, independently of one another, are each an integer from 0 to 20, preferably from 0 to 10, the sum of p and q being>0;

a radical of the formula —O—(CH₂)ᵣ—O—, where r is an integer from 1 to 10, preferably from 1 to 7; or

a radical of the formula

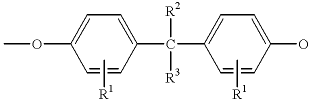

where

R¹, R² and R³, independently of one another, are each hydrogen, C₁- to C₈-alkyl or C₅- to C₇-cycloalkyl.

Such suitable epoxides having two terminal epoxide groups are described in DE-A-21 64 386 and in U.S. Pat. No. 3,373,075, which are hereby incorporated by reference in their entirety.

Suitable compounds B) are furthermore the esters of the abovementioned α,β-ethylenically unsaturated mono- and/or dicarboxylic acids with trihydric and polyhydric alcohols, only some of the hydroxyl groups being esterified, so that the resulting esters also have at least two free hydroxyl groups per molecule.

Suitable trihydric and polyhydric alcohols are the triols and polyols stated below as component E). Preferred partial esters B) are, for example, trimethylolpropane mono(meth)acrylate, erythrityl mono- and di(meth)acrylate, pentaerythrityl mono- and di(meth)acrylate and mixtures thereof.

Preferred compounds B) are the reaction products of 2,3-epoxy-1-propanol or bisphenol A diglycidyl ether with acrylic acid and/or methacrylic acid. Bisphenol A diglycidyl ether is commercially available, for example, as Epikote® 828 from Shell.

Suitable compounds C) are the esters of the abovementioned α,β-ethylenically unsaturated mono- and dicarboxylic acids, preferably of acrylic acid and methacrylic acid, with C₂- to C₂₀-diols, preferably C₂- to C₁₀-diols. These include, for example, 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate etc. and mixtures thereof.

Suitable compounds C) are furthermore the esters of the abovementioned α,β-ethylenically unsaturated mono- and/or dicarboxylic acids with trihydric and polyhydric alcohols. By means of a suitable reaction procedure, only some of the hydroxyl groups of the alcohol component are esterified, so that the resulting esters have one free hydroxyl group per molecule. Suitable alcohols for the preparation of these esters C) are the triols and polyols stated below as component E). Preferred compounds C) are then, for example, erythrityl tri(meth)acrylate, pentaerythrityl tri(meth)acrylate and mixtures thereof.

The abovementioned compounds C) can be used individually or in the form of mixtures.

Suitable polymers D) are, for example, polyols which have a molecular weight of from about 400 to 5000, preferably from about 700 to 2500. The known polyesterpolyols, polyetherols, polycarbonatediols and polycaprolactonediols are suitable for this purpose.

Suitable polyesterols D) are expediently predominantly linear polymers having terminal OH groups, preferably those having two terminal OH groups. The acid number of the polyesterols is in general less than 10, preferably less than 3. The polyesterols can be prepared in a simple manner by esterifying aliphatic, cycloaliphatic or aromatic dicarboxylic acids of 4 to 15, preferably 4 to 6, carbon atoms with glycols, preferably glycols of 2 to 25 carbon atoms, or by polymerizing lactones of 3 to 20 carbon atoms. Examples of suitable dicarboxylic acids are malonic acid, glutaric acid, pimelic acid, suberic acid, sebacic acid, dodecanedioic acid, diphenic acid, isophthalic acid, terephthalic acid, cyclohexanedicarboxylic acid and preferably adipic acid, succinic acid and phthalic acid. The dicarboxylic acids can be used individually or in the form of mixtures. For the preparation of the polyesterols, it may be advantageous to use, instead of the dicarboxylic acids, the corresponding acid derivatives and carboxylic anhydrides or carbonyl chlorides. Mixtures of aromatic dicarboxylic acids, such as phthalic acid, terephthalic acid, isophthalic acid, diphenic acid, or mixtures of these with other dicarboxylic acids, e.g. sebacic acid, succinic acid and adipic acid, are also suitable.

Examples of suitable glycols are diethylene glycol, 1,5-pentanediol, 1,10-decanediol and 2,2,4-trimethyl-1,5-pentanediol. 1,2-Ethanediol, 1,4-butanediol, 1,6-hexanediol and 2,2-dimethyl-1,3-propanediol; 1,4-dimethylolcyclohexane, 1,6-dimethylcyclohexane and 1,4-diethanolcyclohexane; and ethoxylated/propoxylated products of 2,2-bis(4-hydroxyphenylene)propane (bisphenol A) are preferably used. Depending on the desired properties of the polyurethaneacrylates, the polyols may be used alone or in the form of a mixture in various ratios. Suitable lactones for the preparation of the polyesterols are, for example, α, α-dimethyl-β-propiolactone, γ-butyrolactone and preferably ε-caprolactone.

Suitable polyetherols D) are essentially linear substances which have terminal hydroxyl groups, contain ether bonds and have a molecular weight of from about 400 to 5000, preferably from 700 to 2500. Suitable polyetherols can readily be prepared by polymerizing cyclic ethers, such as tetrahydrofuran, or by reacting one or more alkylene oxides having 2 to 4 carbon atoms in the alkylene radical with an initiator molecule which contains two active hydrogen atoms in bound form in the alkylene radical. Examples of alkylene oxides are ethylene oxide, 1,2-propylene oxide, epichlorohydrin and 1,2- and 2,3-butylene oxide. The alkylene oxides may be used individually, alternately in succession or in the form of a mixture. Examples of suitable initiator molecules are water, glycols, such as ethylene glycol, propylene glycol, 1,4-butanediol, 1,6-hexanediol and bisphenol A, amines, such as ethylenediamine, hexamethylene-diamine and 4,4′-diaminodiphenylmethane, and amino alcohols, such as ethanolamine. As in the case of the polyesterols, the polyetherols, too, can be used alone or in the form of mixtures.

Suitable polycarbonatediols D) as well as their preparation are described in U.S. Pat. No. 4,131,731, and are generally based on hexane-1,6-diol.

Suitable polymers D) are furthermore polydiols and polyols which have a molecular weight of from about 5000 to 30,000. The alcohol numbers of these polymers are in general from about 2 to about 15, preferably from 3 to 10, per molecule. The known polyesterols, polyetherols, hydroxyl-containing polycarbonates and hydroxyl-containing polycaprolactams are also suitable for this purpose.

Preferred polyesterols are then, for example, the polycondensates of dibasic and/or polybasic aliphatic, cycloaliphatic and/or aromatic carboxylic acids. Suitable cycloaliphatic dicarboxylic acids are, for example, 1,2-, 1,3- or 1,4-cyclohexanedicarboxylic acid. Suitable aliphatic dicarboxylic acids are, for example, malonic acid, succinic acid, adipic acid etc. Suitable aromatic carboxylic acids are, for example, terephthalic acid, isophthalic acid, phthalic acid, trimellitic acid etc. Suitable alcohol components are in general the abovementioned diols, triols and polyols, such as polyesterols, polyetherols etc. Aliphatic diols, such as ethylene glycol, propylene glycol, 1,6-hexanediol, neopentylglycol, diethylene glycol, polyethylene glycols, polypropylene glycols, 1,4-dimethylcyclohexane etc., are preferably used. Suitable polyesterols D) are available, for example, as Desmophen®, such as Desmophen® 1000, 2000 and 2020, from Bayer AG or Dynapol®, such as Dynapol® L206, from Hüls Troisdorf AG.

Suitable hydroxyl-containing polyethers and polylactones D) are, for example, the Niax® brands from UCC.

The abovementioned polymers D) can be used individually or in the form of mixtures.

The polyurethaneacrylates a) can, if required, comprise, as component E), also a compound which has two or more active hydrogen atoms per molecule and is selected from diols, amines having at least two primary and/or secondary amino groups per molecule, amino alcohols, triols, polyols, water and mixtures thereof.

Suitable amines E) are straight-chain and branched, aliphatic and cycloaliphatic amines having at least two primary and/or secondary amino groups per molecule, which are in general of about 1 to 30, preferably about 1 to 20, carbon atoms. These include, for example, ethylenediamine, 1,2-diaminopropane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 4,9-dioxododecane-1,12-diamine, 4,4′-diaminodiphenylmethane, 4-aminopiperidine and its alkyl derivatives, such as 4-amino-2,6-dimethylpiperidine, 4-amino-2,6-diethylpiperidine, 4-amino-2,6-di-n-propylpiperidine, 4-amino-2,6-diisopropylpiperidine etc., 1-(2-aminoethyl)piperazine, 4,4-diaminodicyclohexylmethane, 4,4′-diaminodiphenylmethane, diethylenetriamine, dipropylenetriamine, triethylenetetramine, 4-azaheptamethylenediamine and N,N′-bis(3-aminopropyl)butane-1,4-diamine and mixtures thereof

Diols of 2 to 18, preferably 2 to 10, carbon atoms and their alkoxylates having a low degree of alkoxylation may also be used as component E), for example 1,2-ethanediol, 1,3-propanediol, 1,4-butanediol, 1,6-hexanediol, 1,5-pentanediol, 1,10-decanediol, 2-methyl-1,3-propanediol, 2-methyl-2-butyl-1,3-propanediol, 2,2-dimethyl-1,3-propanediol, 2,2-dimethyl-1,4-butanediol, 2-ethyl-2-butyl-1,3-propanediol, neopentylglycol hydroxypivalate, diethylene glycol, triethylene glycol, bisphenol A etc. The diols can be used individually or in the form of mixtures. Said diols and diamines E) may be replaced partially, i.e. in an amount of up to 20, preferably up to 10, % by weight, based on the total amount of E), by water.

Other suitable compounds E) are amino alcohols of 2 to 16, preferably 3 to 8, carbon atoms, e.g. monoethanolamine, methylisopropanolamine, ethylisopropanolamine, methylethanolamine, 3-aminopropanol, 1-ethylaminobutan-2-ol, 4-methyl-4-arninopentan-2-ol and N-(2-hydroxyethyl)aniline. Secondary amino alcohols are preferably used.

Suitable triols E) are compounds of 3 to 25, preferably 3 to 18, particularly preferably 3 to 6, carbon atoms. Examples of triols which may be used are glycerol or trimethylolpropane. Low molecular weight reaction products of triols and polyols, for example of trimethylolpropane, with alkylene oxides, such as ethylene oxide and/or propylene oxide, are also suitable. The polyols used may be, for example, erythritol, pentaerythritol and sorbitol. The presence of triols and/or polyols during the polyaddition leads to branching of the end product, which, unless local crosslinking occurs, generally has an advantageous effect on the mechanical properties of the polyurethane.

According to a preferred embodiment, the polyurethaneacrylates a) are composed of

from 1.0 to 10, preferably from 1.4 to 8, mol of at least one compound A),

from 0 to 6, preferably from 0.1 to 5, mol of at least one compound B),

from 0.1 to 6, preferably from 0.2 to 5, mol of at least one compound C),

1.0 mol of at least one component D) and

from 0 to 9.0, preferably from 0.1 to 4, mol of at least one component E).

The polyurethaneacrylates a) are prepared by conventional processes known to a person skilled in the art. The components are preferably used in amounts such that the ratio of NCO equivalents of the compounds of component A) to equivalents of active hydrogen atoms of components B), C), D) and, if present, E) is from about 0.8:1 to 1.2:1, preferably from 0.9:1 to 1.1:1. The temperature is in general from about 20 to 90° C., preferably from 30 to 70° C. The reaction can be carried out without a solvent or in a suitable inert solvent or solvent mixture. Aprotic polar solvents, for example halogenated hydrocarbons, such as chloroform, tetrachloromethane and 1,2-dichloroethane, ketones, such as acetone and methyl ethyl ketone, esters, such as ethyl acetate, nitriles, such as acetonitrile, N-methylpyrrolidone, dimethylformamide, dimethyl sulfoxide, tetrahydrofuran, dioxane etc., are preferably used. If desired, the reaction can be carried out under an inert gas atmosphere, for example under nitrogen. The resulting polyurethanes generally no longer have any free isocyanate groups.

Suitable catalysts for the preparation of the polyurethaneacrylates are, for example, tertiary amines, such as triethylamine, triethylenediamine, N-methylpyridine and N-methylmorpholine; metal salts, such as tin(II) octanoate, lead octanoate and zinc stearate, and organometallic compounds, such as dibutyltin dilaurate. The suitable amount of catalyst is dependent on the efficiency of the suitable catalyst. In general, it has proven expedient to use from 0.005 to 0.3, preferably from 0.01 to 0.1, part by weight per 100 parts by weight of polyurethane.

The preparation of the polyurethaneacrylates a) can be effected in principle by the one-stage process or the two-stage process. In the one-stage process, in general the starting components are dissolved in a part of the solvent so that solutions having a solids content of from about 30 to 80% by weight are formed. The solutions are then heated to the abovementioned reaction temperature while stirring. The components are reacted until the content of isocyanate groups is virtually zero. The solutions can, if desired, then be diluted to a concentration suitable for further processing. Any isocyanate groups still present can finally be reacted with terminating agents, such as monoalcohols or monoamines. In the two-stage process, the isocyanate component A), if necessary in a part of the solvent, is initially taken and is heated to the reaction temperature. The components B), D) and, if required, E), the catalyst and, if required, assistants and additives, if necessary likewise in a part of the solvent, are then added to the isocyanate component A) via one or more feeds while maintaining the reaction. After the end of the addition, the reaction is continued until the content of isocyanate groups in the mixture remains virtually constant. Component C) is then added in a second stage.

The resulting polyurethaneacrylates a) preferably have a K value (measured according to H. Fikentscher, Cellulosechemie 30 (1931), 58 et seq.) of from about 20 to 80, preferably from 25 to 60.

### Component b)

Suitable compounds b), which have three UV-curable α,β-ethylenically unsaturated double bonds per molecule, are, for example, the triesters of the triols stated above as component E) and the alkoxylates thereof with the α,β-ethylenically unsaturated mono- and dicarboxylic acids likewise stated above, preferably acrylic acid and methacrylic acid. These include, for example, propanetriol triacrylate, trimethylolpropane triacrylate, propanetriol trimethacrylate, trimethylolpropane trimethacrylate etc. and their alkoxylates.

Further suitable compounds b) are polyesteracrylates obtained from polyesterols having three hydroxyl groups and α,β-ethylenically unsaturated monocarboxylic acids. Processes for the preparation of polyesteracrylates having three hydroxyl groups are known. They generally contain, as polymerized units, the abovementioned aliphatic and/or cycloaliphatic diols in combination with a suitable amount of triols and the saturated dicarboxylic acids likewise stated above.

Other suitable compounds b) are urethaneacrylates having three α,β-ethylenically unsaturated double bonds. These include, for example, the reaction products of triisocyanates or isocyanate prepolymers having three isocyanate groups with the hydroxyalkyl (meth)acrylates stated above as component C). If desired, the triisocyanates or isocyanate prepolymers can also first be reacted with at least one chain extender selected from the diols, diamines and amino alcohols stated above as component E), and then reacted with an α,β-ethylenically unsaturated mono- or dicarboxylic acid.

Further suitable compounds b) are epoxide acrylates based on triglycidyl ethers. Suitable triglycidyl ethers can be prepared, for example, by reacting the triols stated above as component E) and alcohols which are higher than trihydric and the alkoxylates thereof with epichlorohydrin. The reaction of the alcohols which are higher than trihydric with epichlorohydrin is carried out in a suitable molar ratio, so that essentially triglycidyl ethers result. The triglycidyl ethers can be reacted with the abovementioned α,β-ethylenically unsaturated mono- and/or dicarboxylic acids to give the epoxide acrylates b). Suitable triglycidyl ethers for the preparation of these compounds b) are, for example, trimethylolpropane triglycidyl ether, erythrityl triglycidyl ether, pentaerythrityl triglycidyl ether etc.

### Component c)

Suitable compounds c), which have two UV-curable α,β-ethylenically unsaturated double bonds per molecule, are the diesters of the abovementioned diols, polyetherdiols, polyesterdiols and polycarbonatediols and the alkoxylates thereof with α,β-ethylenically unsaturated mono- and dicarboxylic acids. These include, for example, ethanediol diacrylate, ethanediol dimethacrylate, propanediol diacrylate, propanediol dimethacrylate, butanediol diacrylate, butanediol dimethacrylate, pentanediol diacrylate, hexanediol di(meth)acrylate, heptanediol di(meth)acrylate, octanediol di(meth)acrylate, pentanediol dimethacrylate, neopentylglycol diacrylate, neopentylglycol dimethacrylate, triethylene glycol diacrylate, triethylene glycol dimethacrylate, tetraethylene glycol diacrylate, tetraethylene glycol dimethacrylate, tripropylene glycol diacrylate, tri-propylene glycol dimethacrylate, cyclohexanediol diacrylate, cyclohexanediol dimethacrylate, diacrylates and dimethacrylates of alkoxylated bisphenol A, diacrylates and dimethacrylates of hydrogenated bisphenol A etc. and their alkoxylates.

Further suitable compounds c) are the reaction products described above as component B) and obtained from glycidyl ethers with α,β-ethylenically unsaturated monocarboxylic acids. Bisphenol A diglycidyl ether diacrylate and dimethacrylate (diacrylates and dimethacrylates of Epikote® 828 from Shell) are preferably used. Before their reaction with the unsaturated carboxylic acids, the diglycidyl ethers can, if desired, be reacted with at least one saturated dicarboxylic acid, the molar ratio of diglycidyl ether to dicarboxylic acid being chosen so that essentially products having two terminal epoxide groups result. The prior reaction of the diglycidyl ethers with saturated dicarboxylic acids results in diglycidyl ether di(meth)acrylates having a higher molecular weight and a higher alcohol number.

Suitable compounds d) are, for example, N-vinylamides of carboxylic, sulfonic and phosphonic acids. These include, for example, N-vinylformamide, N-vinylacetamide, N-vinylpropionamide etc. N-Vinylformamide is preferably used.

Suitable monomers d) are furthermore N-vinyllactams and their derivatives, which may have, for example, one or more C₁- to C₆-alkyl substituents, such as methyl, ethyl, n-propyl, isopropyl, n-butyl, sec-butyl, tert-butyl etc. These include, for example, N-vinylpyrrolidone, N-vinylpiperidone, N-vinylcaprolactam, N-vinylmorpholine, N-vinylpiperazine, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam, N-vinyl-4-ethylpiperazine etc.

Suitable monomers d) are furthermore vinyl- and allyl-substituted heteroaromatic compounds, such as 2- and 4-vinylpyridine and 2- and 4-allylpyridine, and preferably N-vinylheteroaromatics, such as N-vinylimidazole, N-vinyl-2-methylimidazole etc.

The novel binder compositions may additionally contain, as component e), at least one ester of an α,β-ethylenically unsaturated monocarboxylic acid with an aliphatic or cycloaliphatic C₁- to C₂₀-monoalcohol. The amount of this component is then in general from about 0 to 30 mol %, based on the total amount of components a) to e).

Suitable monomers e) are the esters of acrylic acid and/or methacrylic acid with methanol, ethanol, n-propanol, isopropanol, n-butanol, sec-butanol, tert-butanol, n-pentanol, n-hexanol, n-heptanol, n-octanol, 2-ethylhexanol, dodecanol, hexadecanol, octadecanol, cyclohexanol etc.

By using the monofunctional monomers d) and/or e), the network density of the novel binder compositions can be varied within a wide range. In general, the amount of monomers d) and/or e) is not more than 40, preferably not more than 30, mol %, based on the total amount of components a) to e). By using monomers of component d), it is generally possible to reduce the viscosity of the binder composition prior to curing, which generally has an advantageous effect on the flow properties and the processibility. Furthermore, an acceleration of the curing rate and/or thorough curing of the binder composition are generally observed in the presence of monomers d). Furthermore, the tolerance of the binder compositions to oxygen and oxidizing agents can generally be improved by using monomers d). Advantageously, rapid surface curing of the binder composition is generally observed with the use of monomers d). The use of monofunctional monomers e) generally leads to binder layers having improved extensibility and/or adhesion.

The abovementioned novel UV-curable binder compositions can, if desired, be used for the preparation of conventional, pigment-free coating materials. These coating materials generally contain at least one or more conventional photoinitiators. Suitable photoinitiators are those stated below, it generally being unnecessary to use any specific mixtures for curing pigment-free coating materials. Preferably, the novel binder compositions are used for the preparation of pigment-containing coating materials, as described below.

The present invention furthermore relates to a UV-curable coating material, comprising

i) at least one novel binder composition as described above,

ii) at least one photoinitiator,

iii) at least one pigment which is selected from carbon black, nonmagnetic and weakly magnetic metal oxides and mixtures thereof, and mixtures which contain carbon black and at least one magnetic pigment,

iv) at least one polyurethane(meth)acrylate having dispersing-active groups, and

v) if required, at least one polyester.

### Component i)

Preferably, the novel coating materials comprise at least one of the binder compositions described above, in an amount from 50 to 95.99, preferably from 60 to 90, % by weight, based on the total amount of components i) to v).

### Component ii)

The novel coating materials contain, as component ii), a mixture of photoinitiators which comprises at least one α-cleaver, at least one H-abstractor and at least one acylphosphine oxide or sulfide. The photoinitiator mixture then preferably comprises from 75 to 98% by weight of the α-cleaver, from 1 to 24% by weight of the H-abstractor and from 1 to 24% by weight of the acylphosphine oxide or sulfide.

The novel coating materials preferably contain the photoinitiator mixture in an amount from 0.01 to 10, preferably from 0.1 to 9.0, in particular from 0.2 to 8, % by weight, based on the total amount of components i) to v).

α-Cleavers are defined in general as photoinitiators which, after irradiation and light absorption, form free radicals with decomposition of the excited initiator by intramolecular bond cleavage. Suitable α-cleavers for the photoinitiator mixtures used according to the invention are selected from benzoin, benzoin ethers, preferably benzoin methyl ether, benzoin ethyl ether and benzoin isopropyl ether, α-alkylbenzoin ethers, benzil ketals, e.g. benzil dimethyl ketal and benzil diethyl ketal, α-acyloxime esters, acetophenone, dialkoxyacetophenones, such as dimethoxyacetophenone, diethoxyacetophenone and di-n-propoxyacetophenone, hydroxyalkylphenones, such as α-hydroxyisobutyrophenone, p-isopropyl-α-hydroxyisobutyrophenone, p-tert-butyl-α-hydroxyisobutyrophenone, p-octyl-α-hydroxyisobutyrophenone, p-dodecyl-α-hydroxyisobutyrophenone, p-chloro-α-hydroxyisobutyrophenone, p-bromo- α-hydroxy-isobutyrophenone, p-methoxy-α-hydroxyisobutyrophenone, p-ethoxy-α-hydroxyisobutyrophenone, 3,4-dimethyl-α-hydroxyisobutyrophenone, 3,4-dimethoxy-α-hydroxyisobutyrophenone, 3-chloro-α-hydroxyisobutyrophenone, α-hydroxy-α-methylbutyrophenone and α-hydroxy-α-ethylbutyrophenone, 1-benzoylcyclopentanol, 1-benzoylcyclohexanol, 1-(4-chlorobenzoyl)cyclohexanol, hydroxycycloalkylphenones, such as hydroxycyclohexylphenone, heterocycloalkylphenones and mixtures thereof. Heterocycloalkylphenones of the Formula I

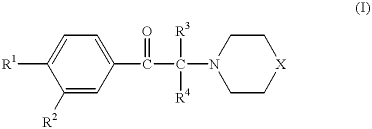

where

R¹ and R², independently of one another, are each hydrogen, C₁- to C₂₀-alkyl, C₁-to C₂₀-alkoxy, C₁- to C₂₀-alkylthio, phenyl, phenoxy, phenylthio or halogen,

R³ and R⁴, independently of one another, are each C₁- to C₆-alkyl, phenyl-C₁-C₆-alkyl or cycloalkyl and

X is CH₂, O, S or NR⁵, where R⁵ is hydrogen, C₁- to C₆-alkyl or cyclohexyl, are preferred.

R¹ is preferably C₁- to C₂₀-alkylthio, in particular methylthio.

R² is preferably hydrogen.

R³ and R⁴, independently of one another, are each preferably C₁- to C₆-alkyl and in particular both are methyl.

X is preferably O or CH₂.

A particularly preferably used α-cleaver is 2-methyl-1-[4-(methylthio)phenyl]-2-morpholinopropan-1-one.

H-abstractors are defined very generally as photoinitiators which, after activation by light absorption, form free radicals by intermolecular hydrogen transfer from a coinitiator to the excited initiator molecule. Suitable coinitiators are, for example, alcohols and primary or secondary amines. In the case of the photoinitiator mixture used according to the invention, it is generally possible to dispense with the addition of a coinitiator since the novel binder composition has sufficient hydroxyl and/or amino groups. Suitable H-abstractors are selected from benzophenone, benzophenone derivatives, such as alkyl-benzophenones, e.g. 4-methylbenzophenone, 4-ethylbenzophenone, 2,4-dimethylbenzophenone and 4-isopropylbenzophenone, halogenated benzophenones, such as 2-chlorobenzophenone and 2,2′-dichlorobenzophenone, alkoxybenzophenones, such as 2-methoxybenzophenone, 4-methoxybenzophenone, 4-propoxybenzophenone and 4-butoxybenzopheonone, benzil, Michler's ketone, anthraquinone, anthraquinone derivatives, such as 2-alkylanthraquinones, e.g. 2-methylanthraquinone, 2-ethylanthraquinone, 2-n-propylanthraquinone and 2-n-butylanthraquinone, thioxanthone, thioxanthone derivatives, such as 1- and 2-alkylthioxanthones and their isomer mixtures, e.g. 1- and 2-methylthioxanthone, 1- and 2-ethylthioxanthone, 1- and 2-n-propylthioxanthone and preferably 1- and 2-isopropylthioxanthone, and 1- and 2-chlorothioxanthone.

Preferred H-abstractors are selected from thioxanthone and thioxanthone derivatives. For example, an isopropylthioxanthone isomer mixture, such as Quantacure® ITX from Shell Chemie, can preferably be used.

Compounds which have both a structural element typical for an α-cleaver and a structural element typical for an H-abstractor are also suitable for use in the photoinitiator mixtures. Such suitable thioxanthone derivatives are described in DE-A-38 26 947, which is hereby incorporated by reference in its entirety. These compounds can be used in the photoinitiator mixtures either only in combination with acylphosphine oxide or sulfide or, if required, additionally in combination with at least one further α-cleaver and/or at least one further H-abstractor.

Photoinitiators suitable as acylphosphine oxide or sulfide components are described in DE-A-40 25 386, DE-A-42 31 579, DE-A-42 40 964, EP-A-0 184 095, EP-A-0 413 657, EP-A-0 446 175, EP-A-0 495 751, EP-A-0 495 752, EP-A-0 513 534 and EP-A-0 615 980, which are hereby incorporated by reference in their entirety. Acylphosphine oxides or sulfides selected from isobutyroyldiphenylphosphine oxide and sulfide, pivaloyldiphenylphosphine oxide and sulfide, benzoyldiphenylphosphine oxide and sulfide, p-toluyldiphenylphosphine oxide and sulfide, p-tert-butylbenzoyldiphenyl-phosphine oxide and sulfide, α-naphthoyldiphenylphosphine oxide and sulfide, 2,6-dimethylbenzoyldiphenylphosphine oxide and sulfide, 2,6-dimethoxybenzoyl-diphenylphosphine oxide and sulfide, 2,4,6-trimethylbenzoyldiphenylphosphine oxide and sulfide, 2,6-dichlorobenzoyldiphenylphosphine oxide and sulfide, 1,3-dimethyl-2-naphthoyldiphenylphosphine oxide and sulfide, 1,3-dichloro-2-naphthoyldiphenylphosphine oxide and sulfide, 2,4-dimethylfuran-3-carbonyldiphenylphosphine oxide and sulfide, 2,4,6-trimethylpyridine-3-carbonyldiphenylphosphine oxide and sulfide, 2,6-dimethoxybenzoyldiphenylphosphine oxide and sulfide, 2,6-dichlorobenzoylditolylphosphine oxide and sulfide, methyl pivaloylphenylphosphinate and -sulfinate, methyl 2,4-dimethylbenzoylphenylphosphinate and -sulfinate, bis(2,6-dichlorobenzoyl)phenylphosphine oxide and sulfide, bis(2,6-dichlorobenzoyl)-4-chlorophenylphosphine oxide and sulfide, bis(2,6-dichlorobenzoyl)-4-tert-butylphenylphosphine oxide and sulfide, bis(2,6-dichlorobenzoyl)-1-naphthylphosphine oxide and sulfide, bis(2,6-dimethylbenzoyl)phenylphosphine oxide and sulfide, bis(2,6-dimethylbenzoyl)-4-tolylphosphine oxide and sulfide, bis(2,6-dimethoxybenzoyl)phenylphosphine oxide and sulfide, bis(2,6-dimethoxybenzoyl)-2-naphthylphosphine oxide and sulfide, bis(2,4,6-trimethylbenzoyl)phenylphosphine oxide and sulfide, bis(2,4,6-trimethylbenzoyl)-4-methoxyphenylphosphine oxide and sulfide, bis(2-methyl-1-naphthoyl)phenylphosphine oxide and sulfide, bis(2,6-dichlorobenzoyl)-4-propylphenylphosphine oxide and sulfide, and mixtures thereof are preferred. In particular, 2,4,6-dimethylbenzoyldiphenylphosphine oxide, bis(2,4,6-trimethylbenzoyl)-phenylphosphine oxide and/or 2,4,6-trimethylbenzoylethoxyphenylphosphine oxide are used.

The photoinitiator mixture used is in particular a mixture of 2-methyl-1-[4-(methylthio)phenyl]-2-morpholinopropan-1-one (Irgacure® 907, from Ciba Spezialitäten-Chemie), isopropylthioxanthone (Quantacure® ITX, from Shell Chemie) and 2,4,6-dimethylbenzoyldiphenylphospine oxide (Lucirin® TPO, from BASF AG), 2,4,6-trimethylbenzoylethoxyphenylphosphine oxide (Lucirin® LR8893, from BASF AG) and/or bis(2,4,6-trimethylbenzoyl)phenylphosphine oxide (from Ciba Spezialitäten-Chemie).

The present invention furthermore relates to the use of the photoinitiator mixture described above, which comprises at least one α-cleaver, at least one H-abstractor and at least one acylphosphine oxide or sulfide, in the curing of carbon black-containing coating materials by UV irradiation. Advantageously, sufficiently high curing rates are obtained when these photoinitiator mixtures are used, so that in general it is possible to use the coating materials in magnetic tape production with the high processing speeds usual there. Thus, it is generally possible to dispense with the technically complicated and expensive use of apparatuses for curing carbon black-containing coating materials by means of electron beams.

The present invention furthermore relates to a novel photoinitiator mixture which contains

at least one acylphosphine oxide or sulfide, as defined above,

at least one α-cleaver, as defined above and

at least one H-abstractor which is selected from benzil, Michler's ketone, anthraquinone, anthraquinone derivatives, thioxanthone, thioxanthone derivatives and mixtures thereof.

Suitable anthraquinone and thioxanthone derivatives are the abovementioned ones. These photoinitiator mixtures are suitable preferably for the curing of pigment-containing and in particular carbon black-containing coating materials.

### Component iii)

All known carbon blacks or carbon black compounds which have electrical conductivity are suitable for the novel, UV-curable coating materials. Preferably, the average particle size of the carbon black is from about 5 to 500 μm, preferably from about 10 to 300 μm. When the novel carbon black-containing coating materials are used as a priming layer in magnetic recording media, it is in general possible to avoid the build-up of electrostatic charge and the associated problems, for example the adhesion of the tape.

Suitable nonmagnetic pigments are, for example, alumina, silica, titanium dioxide, chromium trioxide and zirconium oxide.

Suitable weakly magnetic pigments are the conventional ones known to a person skilled in the art.

Among the abovementioned pigments, carbon black and pigment mixtures which contain carbon black are preferred.

Other suitable components iii) are pigment mixtures which comprise carbon black and at least one of the magnetic pigments stated below and customary for magnetic tape production.

Preferably, the novel coating materials contain the component iii) in an amount from 2 to 40, preferably from 10 to 30, % by weight, based on the total amount of the coating material i) to v).

### Component iv)

The novel, UV-curable coating materials can, if required, contain at least one dispersing resin. This is then used in an amount of from about 0.01 to 50, preferably from 1 to 25, % by weight, based on the total amount of the components i) to v). Suitable polyurethane dispersing resins are described, for example, in DE-A-41 41 838, DE-A-44 46 383 and DE-A-195 16 784, which are hereby incorporated by reference in their entirety.

Polyurethane(meth)acrylates and/or polyurea(meth)acrylates suitable as dispersing resins are obtainable by:

I) reaction of a hydroxyl-containing polymer P1) of:

a) from 80 to 100 mol % of at least one ester of an α,β-ethylenically unsaturated mono- and/or dicarboxylic acid with a C₁- to C₂₅-alkanol,

b) from 0 to 20 mol % of at least one further monomer and

c) at least one initiator and/or regulator by means of which the majority of the polymers P1) are terminated by a hydroxyl group at one of their chain ends,

II) with a difunctional or polyfunctional isocyanate to give a polymer P2), the amount of the isocyanate groups being from 1.2 to 3.9 mol per mole of hydroxyl groups in P1),

III.1) reaction of P2) with ammonia or at least one compound which has amino groups reactive toward isocyanate groups, or

III.2) reaction of P2) with a compound which contains groups reactive toward isocyanate groups to give a polymer P3) and subsequent reaction of P3) with a compound by means of which acidic groups are introduced into the polymer P3), or

III.3) reaction of P2) with at least one compound which has groups reactive toward isocyanate groups and by means of which-acidic groups are introduced into the polymer P2).

### Component v)

The novel coating materials can, if required, contain at least one hydroxyl-containing polymer. This is then used in an amount of from about 0.01 to 50, preferably from about 1 to 45, % by weight, based on the total amount of components i) to v). Preferably, these are polymers which have no α,β-ethylenically unsaturated double bonds. The polydiols and polyols described above as component D) and having a molecular weight from about 5000 to 30,000 are suitable. These include in particular the abovementioned Desmophen® brands from Bayer, Niax® brands from Union Carbide and the Dynapol® brands from Hüls Troisdorf AG and in particular Dynapol® L206.

The novel, UV-curable coating material can, if required, contain further additives. These include, for example, conventional flow improvers and/or lubricants. If required, the novel coating materials may contain at least one inert diluent. Suitable diluents are, for example, aprotic polar solvents, such as dialkylformamides, e.g. dimethylformamide and dimethylacetamide, dimethyl sulfoxide, cyclic ethers, such as tetrahydrofuran and dioxane, N-alkylpyrrolidones, such as N-methylpyrrolidone, ketones, such as acetone and methyl ethyl ketone, etc. Also suitable are alkanes, cycloalkanes and aromatics and mixtures of the abovementioned solvents.

Suitable lubricants are, for example, carboxylic acids of 10 to 25 carbon atoms, in particular stearic acid or palmitic acid, and their salts, esters and/or amides. Preferably, the novel pigment-containing coating materials for the production of magnetic recording media are formulated as a castable mixture. The castable mixture can be prepared in a conventional manner. A carbon black-containing dispersion is prepared, for example in a dispersing apparatus, such as a tubular ball mill or a stirred ball mill, from the components i) to iii) and, if required, iv) and/or v), with or without the addition of one of the abovementioned solvents. If desired, the castable mixture can be filtered by a conventional method before application, for example to separate off agglomerates.

The present invention furthermore relates to a magnetic recording medium, comprising a nonmagnetic substrate and at least one magnetic recording layer which contains a finely divided ferromagnetic powder dispersed in a binder and which is applied over a priming layer on the substrate, wherein the priming layer is derived from at least one UV-cured coating material as described above.

The novel magnetic recording media are produced in a manner known per se.

Suitable nonmagnetic and nonmagnetizable substrate materials are the conventional rigid or flexible substrate materials, in particular films of linear polyesters, such as polyethylene terephthalate, in general in thicknesses of from 2 to 200 μm, in particular from 3 to 100 μm. The use of magnetic layers on paper substrates is also possible.

According to a suitable embodiment, a castable mixture of the novel carbon black-containing, UV-curable coating material is first applied to the substrate. The coating rate is from about 1 to 800, preferably from about 5 to 300, m per minute.

Suitable casting apparatuses for applying the castable mixture to the movably mounted substrate layer are, for example, kiss coaters, bar coaters, blade coaters, knife coaters, roll coaters or reverse-roll coaters etc. After application of the castable mixture to the substrate, curing is effected by means of UV light, if desired the mixture being dried beforehand or simultaneously at elevated temperatures. The UV curing is effected in an apparatus customary for this purpose, by transporting the coated substrate past a source of actinic light having a wavelength of from about 200 to 750 nm, preferably from 200 to 400 nm. Suitable UV radiators or UV lamps are, for example, mercury vapor lamps, high-pressure mercury radiators, excimer lamps, flash lamps, tungsten halide lamps, hollow cathode lamps, helium discharge lamps, excimer lasers, noble gas ion lasers etc.

If the coat is dried before or during the UV curing, the temperature is in general from about 60 to 120° C., preferably from 70 to 110° C. The novel carbon black-containing coating materials are advantageously also suitable for coating the back of the substrate material, serving in particular for improving the mechanical properties of the magnetic recording medium and for reducing the build-up of electrostatic charge during unwinding and rewinding. If desired, two or more priming layers can also be applied to at least one side of the substrate material. If the substrate is coated on both sides and/or if two or more priming layers are applied to at least one side of the substrate, this can be effected simultaneously or at a different time, if necessary after drying or curing of the first priming layer. If desired, the layers can also be applied to the substrate wet-in-wet in one application process, and if necessary dried together and/or cured together. Suitable processes for the simultaneous application of a plurality of layers are known to a person skilled in the art. These include in particular the blade coating or bar coating process, extrusion coating or knife coating process and the cascade coating process. The front and back of the substrate are generally coated at different times.

If desired, before the application of the magnetic layer, the priming layer can be calendered and compacted on conventional calendering apparatuses by being passed between heated and polished rolls at elevated temperatures and, if required, with application of pressure. The temperature during calendering is, as in the case of drying, from about 60 to 120° C., preferably from about 70 to 110° C. The thickness of the carbon black-containing priming layer is in general from about 0.05 to 5 μm, preferably from 0.3 to 3 μm.

The novel, carbon black-containing coating materials which contain a photoinitiator mixture as described above advantageously have such high curing rates that they reliably cure even at the high belt speeds usual in magnetic tape production. The UV-cured films are generally dust-free and solvent-resistant. The novel binder composition used in the coating materials advantageously permits thorough dispersion of the carbon black and, if required, further conventional pigments, so that in general no agglomeration or speck formation occurs.

A conventional magnetic pigment dispersion is used for applying the magnetic layer. Said dispersion generally contains magnetic pigments dispersed in a binder or binder mixture, and, if required, further conventional additives and assistants, such as solvents or diluents, dispersing resins, fillers, lubricants, flow improvers, etc.

Suitable binders for the magnetic material are, for example, polymers which contain, as polymerized units, at least one α,β-ethylenically unsaturated monomer capable of free radical polymerization. Suitable monomers are C₂- to C₈-monoolefins, e.g. ethylene, propylene, 1-butene and 2-butene, vinylaromatics, e.g. styrene, α-methylstyrene, o-chlorostyrene and vinyltoluenes, vinyl and vinylidene halides, e.g. vinyl fluoride, vinylidene fluoride, vinyl chloride and vinylidene chloride, esters of vinyl alcohol with C₁- to C₂₀-monocarboxylic acids, e.g. vinyl formate, vinyl acetate, vinyl propionate, vinyl n-butyrate, vinyl laurate and vinyl stearate, esters of α,β-monoethylenically unsaturated mono- and dicarboxylic acids with C₁- to C₂₀-alkanols, preferably with C₁- to C₈-alkanols, e.g. esters of acrylic acid, methacrylic acid, maleic acid, fumaric acid, itaconic acid and crotonic acid with methanol, ethanol, n-propanol, isopropanol, n-butanol, isobutanol and 2-ethylhexanol, dimethyl maleate and n-butyl maleate, α,β-ethylenically unsaturated nitriles, e.g. acrylonitrile and methacrylonitrile, amides of acrylic and methacrylic acid, nonaromatic hydrocarbons having 2 to 8 carbon atoms and at least two olefinic double bonds, e.g. butadiene, isoprene and chloroprene, and mixtures of these monomers.

Suitable binders for the magnetic material are furthermore cellulose derivatives, e.g. cellulose esters, preferably cellulose nitrates, cellulose acetates, cellulose acetopropionates and cellulose acetobutyrates, and epoxy resins, preferably phenoxy resins, in which, for example, the reaction products of bisphenols, such as bisphenol A with epichlorohydrin, are incorporated.

At least one polyurethane resin is preferably used as the binder for the magnetic material.

Suitable polyurethane resins contain, as polymerized units, at least one isocyanate-containing component which is selected from the abovementioned diisocyanates, polyisocyanates and isocyanate prepolymers. Suitable di-, tri- and polyisocyanates and isocyanate prepolymers are likewise the abovementioned ones. Furthermore, the polyurethane resins contain, as polymerized units, at least one compound which is selected from compounds which contain one or more active hydrogen atoms per molecule. This is selected, for example, from the abovementioned amines, polyamines, diols, triols, polyols and amino alcohols. Furthermore these polyurethane resins generally contain, as polymerized units, compounds which have at least two terminal groups reactive toward isocyanate groups and which additionally contain at least one further functional group per molecule. These are selected, for example, from compounds having at least one α,β-ethylenically unsaturated double bond and/or epoxy function, polymers having at least two terminal groups reactive toward isocyanate groups, compounds which have at least two terminal groups reactive toward isocyanate groups and which additionally have at least one polar functional group selected from carboxyl groups, sulfo groups, phosphonic acid groups, phosphoric acid groups, their alkali metal and alkaline earth metal salts, amino groups and quaternary ammonium groups per molecule, and mixtures thereof.

Suitable polyurethane resins are the binders, described in DE-A-32 27 163 and DE-A-32 27 164, for magnetic materials which are obtainable by crosslinking a polyisocyanate with a hydroxyl-containing polyurethane prepolymer. The polyurethane prepolymer is a thermoplastic polyureaurethane having an OH number of from 10 to 120 (or from 30 to 160), which is prepared from the components

IA. 1 mol of a polydiol having a molecular weight of from 400 to 4000,

IB. from 0.2 to 10 mol (or from 0.2 to 9 mol) of a diol of 2 to 18 carbon atoms,

IC. from 0.1 to 4 mol (or from 0.2 to 10 mol) of a primary or secondary amino alcohol of 2 to 20 carbon atoms.

ID. if required, from 0.01 to 1 mol of a triol of 3 to 18 carbon atoms and

II. from 1.20 to 13 mol of a diisocyanate of 6 to 30 carbon atoms, the proportion of the NCO groups of the diisocyanate, based on the components IA to ID, being from 65 to 95% of the equivalent amount of OH and NH groups.

Some or all of the component IB can be replaced by diamines or amino alcohols having primary or secondary amino groups, corresponding to the component IC. These components serve for the formation of hydroxyl-containing urea groups at the chain ends of the polyurethane prepolymer. Suitable binders B) are also binder mixtures described in DE-A 32 37 163 and comprising the abovementioned hydroxyl-containing poly-ureaurethane and a physically drying binder, for example based on vinylformal groups.

Other suitable binders are the polyurethane binders described in DE-A 39 29 164 and based on a tetrahydrofuran-soluble, isocyanate-free, branched polyurethane containing fluorine groups and having hydroxyl-containing urea groups at the chain ends and a molecular weight of from 4000 to 30,000. This polyurethane binder is prepared from

A) 1 mol of a polyol having a molecular weight of from 400 to 4000,

B) from 0.3 to 9 mol of a diol of 2 to 18 carbon atoms,

C) from 0.01 to 1 mol of a triol of3 to 18 carbon atoms,

D) from 0.001 to 0.4 mol of a perfluoro compound having two terminal groups reactive toward isocyanates and a molecular weight of from 300 to 4000,

E) from 1.25 to 13 mol of a diisocyanate of 6 to 30 carbon atoms, the NCO:OH ratio in the sum of the components A, B, C and D being from 1.05:1.0 to 1.4:1.0, and

F) from 0.1 to 4 mol of a primary or secondary amino alcohol of 2 to 20 carbon atoms.

For the formation of prepolymers having hydroxyl groups at the chain ends, the components A to E are reacted to give an isocyanate-containing intermediate and this is then reacted with the amino alcohol F. The polyurethanes described in DE-A-39 29 165 are also suitable, from 0.01 to 0.4 mol of an organofunctional polysiloxane compound having two terminal groups reactive toward isocyanates and a molecular weight of from 300 to 4000 being used as component D), in contrast to DE-A-39 29 164.

Other suitable binders are the polyurethane resins which are described in German patent application P 197 57 670.2 and are obtainable by crosslinking at least one polyisocyanate with at least one isocyanate-free polyurethane prepolymer containing at least 3 active hydrogen atoms, the polyurethane prepolymer having at least two hydroxyl groups and at least one primary and/or secondary amino group.

The abovementioned steps are hereby incorporated by reference in their entirety. The binders for the magnetic material can, if required, additionally contain a physically drying cobinder. Such physically drying cobinders are known in principle. They include polyvinyl formal binders which are prepared by hydrolysis of a polymer of a vinyl ester and subsequent reaction of the resulting vinyl alcohol polymer with formaldehyde. The polyvinyl formals expediently have a vinyl formal group content of at least 65, in particular at least 80, % by weight. Particularly suitable polyvinyl formals contain from 5 to 13% by weight of vinyl alcohol groups and from 80 to 88% by weight of vinyl formal groups and have a density of about 1.2 and a viscosity of from 50 to 120 mPa.s, measured at 20° C., using a solution of 5 g of polyvinyl formal in 100 ml of phenol/toluene (1:1). Also suitable in addition to the polyvinyl formal are vinyl chloride/diol mono- or di(meth)acrylate copolymers, which can be prepared, for example in a manner known per se, by solution copolymerization or suspension copolymerization of vinyl chloride and the diol mono(meth)acrylate or di(meth)acrylate. The diol mono- or diacrylate or mono- or dimethacrylate used for this purpose is an esterification product of acrylic acid or methacrylic acid with the corresponding molar amount of aliphatic diol of 2 to 4 carbon atoms, such as ethylene glycol, 1,4-butanediol and preferably propanediol, the propanediol preferably comprising 1,3-propanediol and from 0 to 50% by weight of 1,2-propanediol. The copolymers expediently have a vinyl chloride content of from about 50 to 95% by weight and a diol acrylate or methacrylate content of from about 5 to 50% by weight. Particularly suitable copolymers preferably have a vinyl chloride content of from about 70 to 90% by weight and a diol monoacrylate or monomethacrylate content of from 10 to 30% by weight. A 15% strength solution of particularly suitable copolymers, such as vinyl chloride/propanediol monoacrylate copolymers, in a mixture of equal parts by volume of tetrahydrofuran and dioxane has a viscosity of about 30 mPa.s at 25° C. The K values of the particularly suitable products is in general from 3 to 50, preferably about 40.

Furthermore, phenoxy resins having repeating units of the formula

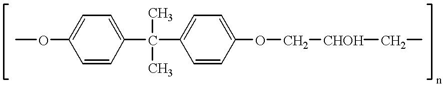

where n is about 100, can advantageously be used as cobinders. These are polymers such as those known under the tradenames Epikote® from Shell Chemical Co. or under the name epoxy resin PKHH® from Union Carbide Corporation.

The abovementioned cellulose ester binders are also suitable as cobinders. The use of vinyl chloride copolymers having sulfonate groups, for example according to U.S. Pat. No. 4,748,084, as cobinders has proven advantageous, said copolymers being available as the commercial product MR 110® from Nippon Zeon.

According to a preferred embodiment, the binders used according to the invention contain from 0 to 30% of a dispersing resin. Suitable dispersing resins are described, for example, in DE-A-195 16 784, DE-A-41 41 848 and DE-A-44 46 383, which are hereby incorporated by reference in their entirety.

Preferred binders for magnetic material are those which contain from 5 to 25, preferably from 10 to 20, % by weight, based on the total amount of binder, of these dispersing resins.

The further processing of the binder mixture with magnetic materials and assistants to give magnetic recording media is effected in a manner known per se.

The pigments known per se which substantially influence the properties of the resulting magnetic layers, e.g. gamma-iron(III) oxide, finely divided magnetite, ferromagnetic undoped or doped chromium dioxide, cobalt-modified gamma-iron(III) oxide, barium ferrites or ferromagnetic metal particles, may be used as anisotropic magnetic materials. Acicular, in particular dendrite-free, cobalt-modified or unmodified gamma-iron(III) oxide and ferromagnetic chromium dioxide and metal pigment are preferred. The use of metal pigment is particularly preferred. The specific surface area is in general at least 15 m²/g (BET method), preferably from 30 to 200 m²/g.

The binders for the magnetic material can be used in formulations without additional use of low molecular weight dispersants. However, it is also possible to add minor amounts of dispersants, e.g. lecithin, zinc oleate or zinc stearate.

Furthermore, the magnetic layers may contain small amounts of additives, such as lubricants and/or fillers, which can be mixed in during the dispersing of the magnetic materials or during the production of the magnetic layer. Examples of such additives are salts of fatty acids or isomerized fatty acids, such as stearic acid, with metals of the first to fourth main groups of the Periodic Table of the Elements, and fatty esters, such as butyl stearate, or waxes, silicone oils, carbon black etc. The amount of additive is a customary amount and is in general less than 10% by weight, based on the total amount of the magnetic layer.

The ratio of magnetic material to binder in the novel recording materials is from about 1 to 12, in particular from 3 to 8, parts by weight of magnetic material to about one part by weight of the total binder.

The magnetic layer is applied to the substrate, provided with at least one priming layer, likewise by conventional methods known to a person skilled in the art. Analogously to the application process for the priming layer, preferably a castable mixture of the dispersion of magnetic material in at least one binder, with or without the addition of at least one further cobinder and/or further additives, is prepared and is applied to the movably mounted, nonmagnetic substrate material. The preparation of the magnetic pigment dispersion can be effected analogously to the preparation of the carbon black-containing coating material in a conventional dispersing apparatus. Said dispersion, if necessary after filtration, is applied to the movable, nonmagnetic substrate material by means of one of the abovementioned conventional coating apparatuses. If binders based on polyurethanes are used, the coatings can generally be applied to the nonmagnetic substrate at high speeds. Thereafter, they can be dried at from about 60 to 120° C., preferably from about 80 to 110° C., calendered and, if required, postcured. The application rate is in general from about 1 to 1500, in particular from 300 to 900, m per minute. As a rule, magnetic orientation is effected before the liquid magnetic dispersion is dried on the substrate. The magnetic layers can, if necessary after a certain residence time, be calendered and compacted on conventional calendering apparatuses by being passed between heated and polished rolls at elevated temperatures and, if required, with application of pressure. The temperature during calendering is, as in the case of drying, from about 60 to 120° C., preferably from about 70 to 100° C. The thickness of the magnetic layer is in general from about 0.5 to 20 μm, preferably from about 1 to 10 μm. In the case of the production of magnetic tapes, the coated films are slit in the longitudinal direction into the conventional widths generally specified in inches.

### EXAMPLES

The nonrestrictive examples which follow illustrate the invention.

### Example 1 (novel binder composition)

kg of a solvent mixture comprising tetrahydrofuran and dioxane (1:1) were initially taken at room temperature in a stirred container equipped with a high-speed stirrer, and 6.0 kg of a polyurethane acrylate solution¹⁾ (20.0% strength by weight in 1:1 tetrahydrofuran/dioxane), 1.18 kg of trimethylolpropane triacrylate, 0.51 kg of ethylene glycol diacrylate, 0.9 kg of bisphenol A diglycidyl ether diacrylate, 1.0 kg of an N-vinylcaprolactam solution (50% strength by weight in 1:1 tetrahydrofuran/dioxane) and 0.4 kg of ethyl acrylate and 1.0 kg of a polyesterdiol (molecular weight about 20,000, Dynapol® L206 from Hüls Troisdorf AG) and 2.93 kg of additional solvent (1:1 tetrahydrofuran/dioxane) were introduced while stirring. A mixture of 5.50 kg of tetrahydrofuran/dioxane (1:1), 0.01 kg of a leveling agent (Flourad® FC 430), 0.35 kg of 2-methyl-1-[4-(methylthio)phenyl]-2-morpholinopropan-1-one (Irgacure® 907, Ciba Spezialitäten-Chemie) and 0.025 kg of isopropylthioxanthone (Quantacure® ITX, from Shell Chemie) was then added with vigorous stirring.

The unpigmented dispersion thus obtained was applied by means of a conventional knife coater to a 36 μm thick polyethylene terephthalate film at a speed of 45 m/min and was dried in a 4 m long drying tunnel at 80° C. The about 1 μm thick layer was then cured in the air by passing it under a UV lamp (200 watt/cm, wavelength from 200 to 400 nm). The UV-cured adhesion-promoting layer thus obtained was insoluble in tetrahydrofuran/dioxane (1:1) and defect-free. It was immediately overcoated inline with a conventional magnetic dispersion based on iron oxide (in tetrahydrofuran/dioxane (1:1)). The magnetic data medium thus produced was defect-free and exhibited excellent adhesive strength.

### Example 2 (novel binder composition and coating material)

26.0 kg of a solvent mixture comprising tetrahydrofuran and dioxane (1:1) were initially taken at room temperature in a stirred container equipped with a high-speed stirrer, and 5.0 kg of a polyurethane acrylate solution¹⁾ (20.0% strength by weight in 1:1 tetrahydrofuran/dioxane), 0.94 kg of trimethylolpropane triacrylate, 0.40 kg of ethylene glycol diacrylate, 0.72 kg of bisphenol A diglycidyl ether diacrylate, 0.8 kg of an N-vinylcaprolactam solution (50% strength by weight in 1:1 tetrahydrofuran/dioxane) and 0.32 kg of ethyl acrylate and 1.0 kg of a polyesterdiol (molecular weight about 20,000, Dynapol® L206 from Hüls Troisdorf AG) and 2.93 kg of additional solvent (1:1 tetrahydrofuran/dioxane) were introduced while stirring. A mixture of 5.0 kg of tetrahydrofuran/dioxane (1:1), 0.01 kg of a leveling agent (Flourad® FC 430), 0.01 kg of 2-methyl-1-[4-(methylthio)phenyl]-2-morpholinopropan-1-one (Irgacure® 907, Ciba Spezialitäten-Chemie), 0.29 kg of isopropylthioxanthone (Quantacure® ITX, from Shell Chemie) and 0.01 kg of 2,4,6-dimethylbenzoyldiphenylphosphine oxide (Lucirin® TBO, from BASF AG) was then added with vigorous stirring. Thereafter, 1.35 kg of conductive carbon black (XL72, BET surface area 45 m²/g) and 0.535 kg of a 50% strength by weight solution (in tetrahydrofuran/dioxane (1:1)) of a dispersing resin based on a polyurethaneacrylate having dispersing-active SO₃Na groups were stirred in thoroughly and stirring was then continued for a further half hour.

The carbon black dispersion thus obtained was applied by means of a conventional knife coater to a 36 μm thick polyethylene terephthalate film at a speed of 45 m/min and dried in a 4 m long drying tunnel at 80° C. The about 1 μm thick layer was then cured in the air by passing it under a UV lamp (200 watt/cm, wavelength from 200 to 400 nm). The UV-cured adhesion-promoting layer thus obtained was insoluble in tetrahydrofuran/dioxane (1:1) and defect-free. It was immediately overcoated inline with a conventional magnetic dispersion based on iron oxide (in tetrahydrofuran/dioxane (1:1)). The magnetic data medium thus produced was defect-free and exhibited excellent adhesive strength and a conductivity better by a factor of 10 than that of an adhesion-promoting layer without carbon black.

1) 16.5% strength by weight solution in tetrahydrofuran/dioxane (1:1), polyurethaneacrylate obtained from:

9.99 kg of toluene diisocyanate

82.76 kg of polycarbonatediol, MW of about 2000

54.87 kg of polyesterdiol, MW about 20,000 (Dynapol® L206 from Hüls Troisdorf AG)

28.35 kg of an adduct of 2 mol of ethylene oxide with 1 mol of bisphenol A (Dianol® 22)

6.5 kg of 1,6-hexanediol

0.47 kg of trimethylolpropane

27.30 kg of bisphenol A diglycidyl ether diacrylate (diacrylate of Epikote® 828 from Shell)

2.88 kg of butanediol monoacrylate

53.10 kg of diphenylmethane diisocyanate

### Comparative Example 1

The procedure corresponded to that of example 2, except that no 2,4,6-dimethylbenzoyldiphenylphosphine oxide was added as a photoinitiator. The adhesion-promoting layer thus obtained is still soluble in tetrahydrofuran/dioxane (1:1) and is tacky, and the magnetic dispersion applied as an overcoat mixed with the adhesion promoter and was useless.

### Comparative Example 2

The procedure was analogous to that of example 2, except that no vinylcaprolactam was used for the production of the adhesion-promoting layer. The adhesion-promoting layer was still soluble in tetrahydrofuran/dioxane (1:1) and was useless.

### Comparative Example 3

The procedure was analogous to that of Example 2, except that no polyurethaneacrylate having dispersing-active groups was used for the production of the adhesion-promoting layer. The dispersed carbon black was poorly distributed in the adhesion-promoting layer, and nodules and specks formed in the adhesion-promoting layer. The magnetic data medium obtained after overcoating with the magnetic dispersion based on iron oxide had a large number of defects and was useless.

We claim:

1. A UV-curable binder composition, comprising
a) at least one polyurethaneacrylate having a number average molecular weight of from 10,000 to 80,000 and an average number from 4 to 15 of UV-curable α,β-ethylenically unsaturated double bonds per molecule,
b) at least one compound having a molecular weight of from 254 to 1000 and three UV-curable α,β-ethylenically unsaturated double bonds per molecule,
c) at least one compound having a molecular weight from 170 to 1000 and two UV-curable α,β-ethylenically unsaturated double bonds per molecule,
d) at least one α,β-ethylenically unsaturated compound which is selected from N-vinylamides, N-vinyllactams, vinyl- and allyl-substituted heteroaromatic compounds and mixtures thereof, and
e) if required, at least one ester of an α,β-ethylenically unsaturated monocarboxylic acid with an aliphatic or cycloaliphatic C₁- to C₂₀-mono-alcohol.

2. A binder composition as claimed in claim 1, comprising
from 0.003 to 0.015 mol of at least one polyurethaneacrylate a),
from 0.2 to 1.5 mol of at least one compound b),
from 0.2 to 1.8 mol of at least one compound c),
from 0.1 to 4.0, preferably from 0.3 to 4.0, mol of at least one α,β-ethylenically unsaturated compound d), and
from 0 to 4.0 mol of at least one ester e).

3. A binder composition as claimed in claim 1, wherein the content of UV-curable α,β-ethylenically unsaturated double bonds is from 2.5 to 7.0, preferably from 4.0 to 6.0, mol per 1000 g of binder composition.

4. A binder composition as claimed in claim 1, wherein the average double bond functionality is not more than 1.8, preferably not more than 1.6, per molecule, based on the components a) to e).

5. A UV-curable binder, comprising
i) at least one binder composition as claimed in claim 1,
ii) at least one photoinitiator,
iii) at least one pigment which is selected from carbon black, nonmagnetic and weakly magnetic metal oxides and mixtures thereof, and mixtures which contain carbon black and at least one magnetic pigment,
iv) at least one polyurethane(meth)acrylate having dispersing-active groups and
v) if required, at least one polyester.

6. A coating material as claimed in claim 5, wherein a mixture of photoinitiators which comprises at least one α-cleaver, at least one H-abstractor and at least one acylphosphine oxide or sulfide is used as component ii).

7. A coating material as claimed in claim 6, wherein the photoinitiator mixture comprises from 75 to 98% by weight of the α-cleaver, from 1 to 24% by weight of the H-abstractor and from 1 to 24% by weight of the acylphosphine oxide or sulfide.

8. A coating material as claimed in claim 6, wherein the α-cleaver is selected from benzoin, benzoin ethers, α-alkylbenzoin ethers, benzil ketals, α-acyloxime esters, acetophenone, dialkoxyacetophenones, hydroxyalkylphenones, hydroxycycloalkylphenones, hetereocycloalkylphenones and mixtures thereof.

9. A coating material as claimed in claim 6, wherein the H-abstractor is selected from benzophenone, alkylbenzophenones, halogenated benzophenones, alkoxy-benzophenones, benzil, Michler's ketone, anthraquinone, anthraquinone derivatives, thioxanthone, thioxanthone derivatives and mixtures thereof.

10. A photoinitiator mixture as defined in claim 6, the α-cleaver being 2-methyl-1-[4(methylthio)phenyl]-2-morpholinopropan-1-one, the H-abstractor being isopropylthioxanthone and the acylphosphine oxide component being selected from 2,4,6-dimethylbenzoyldimethylphosphine oxide, 2,4,6trimethylbenzoylethoxyphenylphosphine oxide, bis(2,4,6-trimethylbenzoyl)-phenylphosphine oxide and mixtures thereof.

11. The use of a photoinitiator mixture as claimed in claim 10 in the curing of carbon black-containing coating materials by UV irradiation.

12. A magnetic recording medium, comprising a nonmagnetic substrate and at least one magnetic recording layer which contains a finely divided ferromagnetic powder dispersed in a binder and which is applied over a priming layer on the substrate, wherein the priming layer is derived from at least one UV-cured coating material as claimed in claim 5.
